(19) United States
(12) Patent Application Publication
(10) Pub. No.: US 2008/0115109 A1
(43) Pub. Date: May 15, 2008

(54) Enhanced Hover Help For Software Debuggers

(76) Inventors: James E. Bostick, Cedar Park, TX (US); Brian W. Hansen, Round Rock, TX (US); Raghuraman Kalyanaraman, Austin, TX (US)

Correspondence Address: IBM CORPORATION (RUS);c/o Rudolf O Siegesmund Gordon & Rees, LLp, 2100 Ross Avenue, Suite 2800, DALLAS, TX, 75201, US

(21) Appl. No.: 11/559,183

(22) Filed: Nov. 13, 2006

(51) Int. Cl. G06F 11/36

(52) U.S. Cl. 717/125

(57) ABSTRACT

A “Classpath Identifier” displays a current classpath for a line of code in a computer application as part of a help dialog box in a software debugger program. Responsive to the help dialog box activating for the line of code, the Classpath Identifier obtains from a compiler the classpath associated with the line of code and displays the classpath in the help dialog box. Additionally, the Classpath Identifier displays the name and the location of a JAR file containing the line of code.

### FIELD OF THE INVENTION

The present invention relates generally to data processing systems and relates specifically to displaying classpath and JAR file information in the hover help of a software debugger.

### BACKGROUND OF THE INVENTION

Software developers migrate computer applications from a first environment to a second environment in the normal course of their work. For example, when software developers complete a new computer application, they must migrate the new computer application from a development environment to a work environment where the application can be used by others. In another example, existing applications are migrated from a first environment on an old server or computer running an old operating system to a second environment on new server or a computer running new operating system. Even when a computer application runs properly in a first environment, errors may occur when running the computer application in a second environment.

In order to prevent errors, software developers test, or “debug,” the computer application in the second computer environment to verify that the computer application runs properly in the second environment. To test the computer application in the second environment, software developers use a debugger. Debuggers run each line of code in the computer application in sequence, one line of code at a time, to identify any errors that may occur for each line of code. Debuggers often employ a feature called a help dialog box to assist in the debugging process. A help dialog box contains additional information about an element on a computer display in response to the user performing a predefined action related to the element. For example, a help dialog box may open when a user right clicks on the element, or selects “help” from a menu when the element is highlighted. In another example, “Hover help” is a help dialog box that opens when a user places a mouse cursor over the element. U.S. Patent. App. No. 2005/0114778 A1 discloses hover help for displaying information in response to a mouse cursor positioned over a feature on a computer display. In the context of a debugger, hover help displays information about a line of code when the developer places a mouse cursor over the line of code. A debugger's help dialog box information may describe the usage of a command in the line of code, the types of arguments that can be used with the command, and the types of responses that can be generated by the command.

JAVA is a programming language used by software developers to create computer applications. JAVA computer applications are often made up of several partial computer applications called “Applets.” Each Applet used by a JAVA computer application can be stored and run from separate physical or logical locations. For example, an Applet on a server computer and an Applet on a client computer can run together as part of a single JAVA computer application. Because portions of a JAVA computer application can be run on separate computers, the JAVA programming language is particularly well suited for internet based computer applications used on the World Wide Web.

In order to run Applets located on different computers together in a single JAVA computer application, the JAVA programming language employs a structure for defining and locating each Applet used by a JAVA computer application. The structure employs “classpaths” and import statements to tell a JAVA compiler where to locate Applets used by a JAVA computer application. A classpath is a JAVA environment variable that tells a JAVA compiler where to find one or more “class files.” A “class file” is a complied JAVA source code for a JAVA computer application or Applet, using a precisely defined file format. Class files are stored in a “JAR file” (JAR is an abbreviation of “JAVA Archive”) bundled with associated auxiliary resources containing everything needed for a single JAVA computer application or Applet to run. JAVA compilers use an “import statement” to locate related resources and class files using a fully qualified class name. Alternatively, software developers can define a set of import statements to list each individual resource and class file related to a common classpath. Software developers must be careful to ensure that the classpath and import statements are correct, or else the JAVA computer application will not be able to locate JAR files containing the class files for the Applets that make up the JAVA computer application.

When migrating JAVA computer applications from a first environment to a second environment, software developers encounter three common errors. Either a classpath is not set up properly for the second environment, contents are missing from a required JAR file, or a required JAR file is missing. With any of these errors, the JAVA computer application cannot locate the required JAR file or JAR file contents. If the classpath is not set up correctly, the JAVA compiler will not look for class files in the correct location. If some of contents of the required JAR file are missing, such as an instruction set or resource, the JAVA compiler will not be able to locate or run the required JAR file contents. If the required JAR file containing the class file was not copied to the second environment, or if the required JAR file was not copied to the proper directory in the second environment, then the JAVA compiler will not be able to locate the required JAR file. Current debuggers can identify a line of code where a required JAR file is not found, but current debuggers cannot tell the software developer where the required JAR file should be located because current debuggers do not display the classpath associated with the line of code.

Currently, to find a missing JAR file, a software developer must rigorously search each JAR file in the first environment to see which JAR file contains the line of code causing the error. The developer can then ensure that the required JAR file has been copied to the correct directory in the second environment. Once the developer knows where the required JAR file should be located, the developer can ensure that the classpath is correct. A need exists for a method to obtain the classpath for a selected line of code from the JAVA compiler and display the current classpath when using a JAVA debugger. (The classpath is identified by the JAVA compiler as part of the compiling process prior to debugging the JAVA computer application.) Additionally, the method should display the name and location of the JAR file containing the line of code. If a software debugger displays the classpath and the name and the location of the JAR file for a line of code, developers can quickly identify and correct the exact problem when the JAVA computer application works in a first environment but not in a second environment.

### SUMMARY OF THE INVENTION

A “Classpath Identifier” displays a current classpath for a line of code in a computer application as part of a help dialog box in a software debugger program. Responsive to the help dialog box activating for the line of code, the Classpath Identifier obtains from a compiler the classpath associated with the line of code and displays the classpath in the help dialog box. Additionally, the Classpath Identifier displays the name and the location of a JAR file containing the line of code.

### BRIEF DESCRIPTION OF DRAWINGS

The novel features believed characteristic of the invention are set forth in the appended claims. The invention itself, however, as well as a preferred mode of use, further objectives and advantages thereof, will be understood best by reference to the following detailed description of an illustrative embodiment when read in conjunction with the accompanying drawings, wherein:

FIG. 1 is an exemplary computer network;

FIG. 2 describes programs and files in a memory on a computer;

FIG. 3 is a flowchart of a hover help plug-in;

FIG. 4 is an exemplary hover help dialog box;

FIG. 5 is an exemplary hover help dialog box using the Classpath Identifier; and

FIG. 6 is an exemplary hover help dialog box using the Classpath Identifier.

### DETAILED DESCRIPTION OF THE PREFERRED EMBODIMENT

The principles of the present invention are applicable to a variety of computer hardware and software configurations. The term “computer hardware” or “hardware,” as used herein, refers to any machine or apparatus that is capable of accepting, performing logic operations on, storing, or displaying data, and includes without limitation processors and memory. The term “computer software” or “software,” refers to any set of instructions operable to cause computer hardware to perform an operation. A “computer,” as that term is used herein, includes without limitation any useful combination of hardware and software, and a “computer program” or “program” includes without limitation any software operable to cause computer hardware to accept, perform logic operations on, store, or display data. A computer program may, and often is, comprised of a plurality of smaller programming units, including without limitation subroutines, modules, functions, methods, and procedures. Thus, the functions of the present invention may be distributed among a plurality of computers and computer programs. The invention is described best, though, as a single computer program that configures and enables one or more general-purpose computers to implement the novel aspects of the invention. For illustrative purposes, the inventive computer program will be referred to as the “Classpath Identifier”

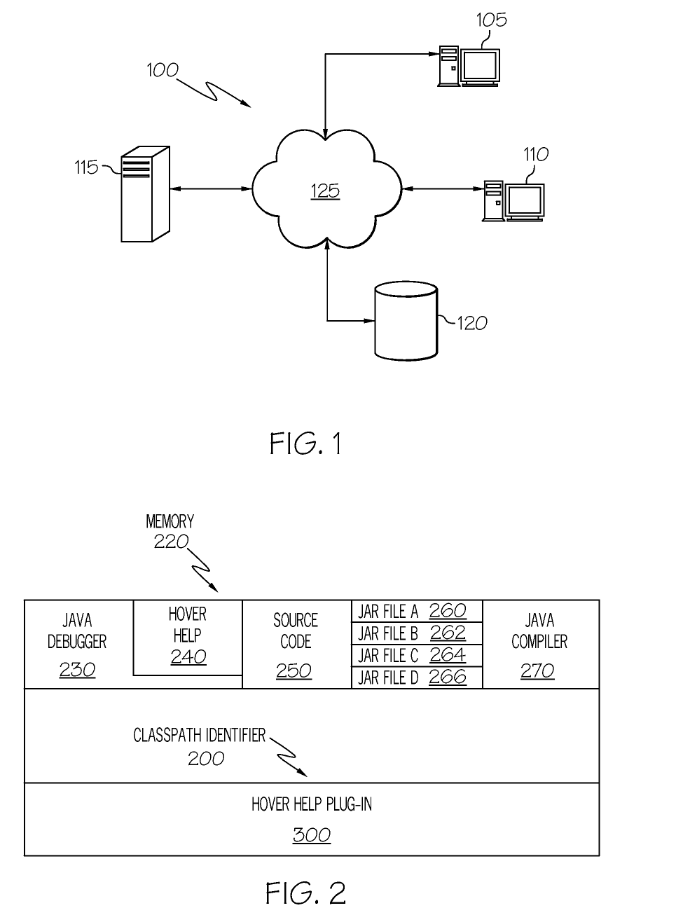

Additionally, the Classpath Identifier is described below with reference to an exemplary network of hardware devices, as depicted in FIG. 1. A “network” comprises any number of hardware devices coupled to and in communication with each other through a communications medium, such as the Internet. A “communications medium” includes without limitation any physical, optical, electromagnetic, or other medium through which hardware or software can transmit data. For descriptive purposes, exemplary network 100 has only a limited number of nodes, including workstation computer 105, workstation computer 110, server computer 115, and persistent storage 120. Network connection 125 comprises all hardware, software, and communications media necessary to enable communication between network nodes 105-120. Unless otherwise indicated in context below, all network nodes use publicly available protocols or messaging services to communicate with each other through network connection 125.

Classpath Identifier 200 typically is stored in a memory, represented schematically as memory 220 in FIG. 2. The term “memory,” as used herein, includes without limitation any volatile or persistent medium, such as an electrical circuit, magnetic disk, or optical disk, in which a computer can store data or software for any duration. A single memory may encompass and be distributed across a plurality of media. Further Classpath Identifier 200 may reside in more than one memory distributed across different computers, servers, logical partitions, or other hardware devices. The elements depicted in memory 220 may be located in or distributed across separate memories in any combination, and Classpath Identifier 200 may be adapted to identify, locate and access any of the elements and coordinate actions, if any, by the distributed elements. Thus, FIG. 2 is included merely as a descriptive expedient and does not necessarily reflect any particular physical embodiment of memory 220. As depicted in FIG. 2, though, memory 220 may include additional data and programs. Of particular import to Classpath Identifier 200, memory 220 may include JAVA debugger 230, source code 250, JAR file A 260, JAR file B 262, JAR file C 264, JAR file D 266, and JAVA compiler 270 with which Classpath Identifier 200 interacts. JAVA debugger 230 incorporates existing art component hover help 240. Classpath Identifier 200 has one component, hover help plug-in 300.

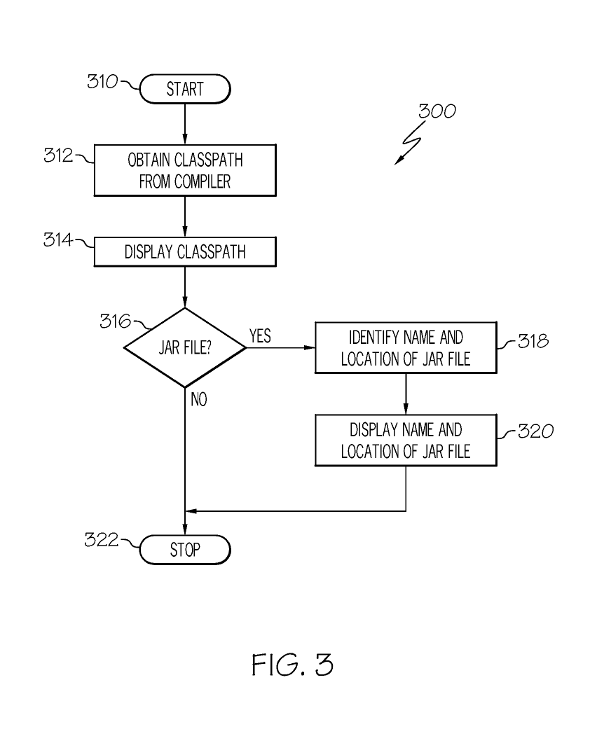

Hover help plug-in 300, shown in FIG. 3, starts whenever a user of JAVA debugger 230 activates hover help 240 (310). Hover help 240 is generally activated whenever a software developer places a mouse cursor over a selected line of code in source code 250 while debugging source code 250 with debugger 230. Hover help plug-in 300 obtains the classpath related to the selected line of code in source code 250 from JAVA compiler 270 (312). 250 when source code 250 was compiled as part of or prior to the debugging process. Hover help plug-in 300 displays the classpath in the hover help dialog box (314). Hover help plug-in 300 determines if the selected line of code in source code 250 is located in a JAR file, such as JAR file A 260 (316). Hover help plug-in 300 determines whether the selected line of code is located in a JAR file by referencing information available from JAVA compiler 270. If the selected line of code is located in a JAR file, such as JAR file A 260, hover help plug-in 300 identifies the name and location of JAR file 360 (318) and displays the name and location of JAR file A 260 in the hover help dialog box (320). After displaying the classpath and JAR file, hover help plug-in 300 stops (322).

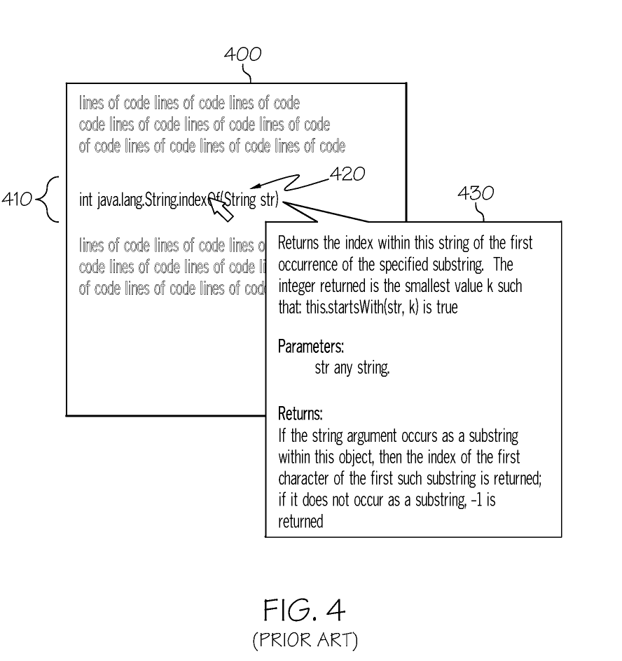

FIG. 4 depicts prior art hover help dialog box 430 used by a software debugger. Mouse cursor 420 is located over line of code 410 in debugger display 400. Hover help dialog box 430 displays information related to the commands and arguments in line of code 410.

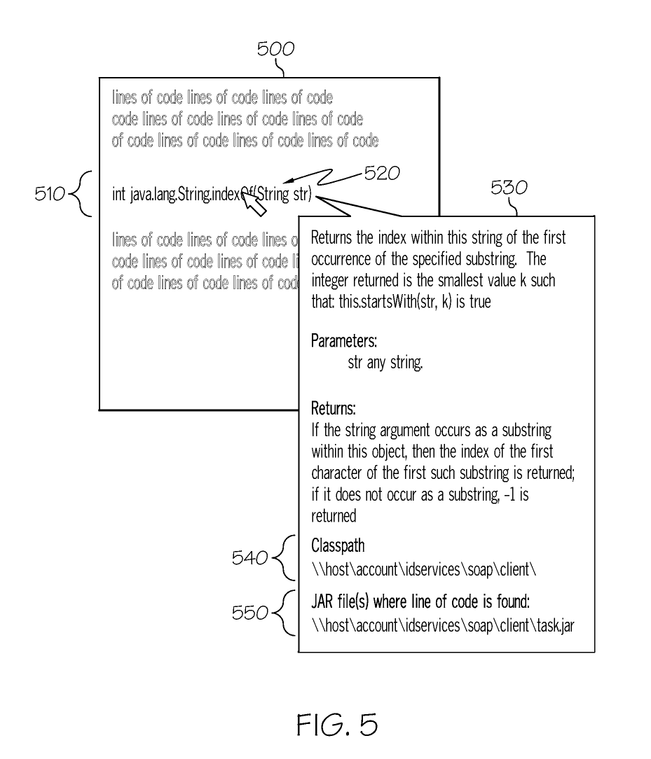

FIG. 5 depicts hover help dialog box 530. Hover help dialog box 530 is the same as hover help dialog box 430 in FIG. 4, but hover help dialog box 530 shows the additional information provided by class path identifier 200. Hover help dialog box 530 opens when mouse cursor 520 is located over line of code 510 in debugger display 500. In addition to the information related to the commands and arguments in line of code 510, hover help dialog box 530 contains classpath display 550 showing the classpath for line of code 510 and JAR file display 560 showing the name and location of JAR file containing line of code 510.

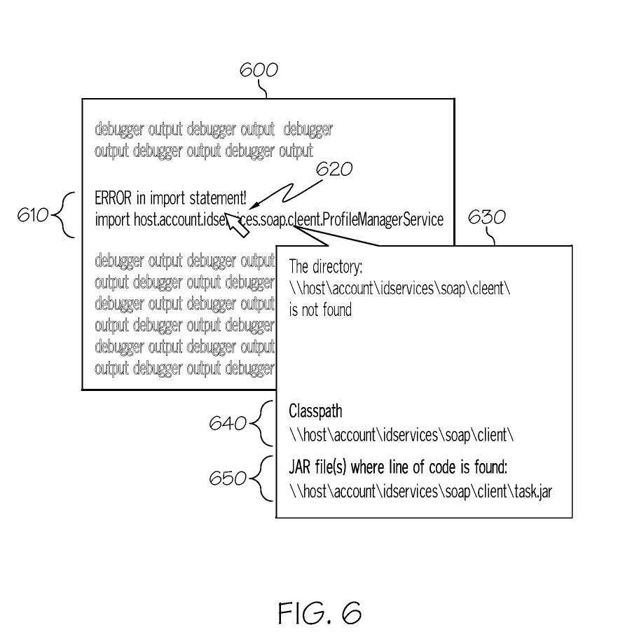

FIG. 6 shows debugger hover help dialog box 630 with hover help plug-in 300 applied to an import statement error in a software debugger. Mouse cursor 620 is located over import statement 610 in debugger display 600. In addition to the information related to the error found when running import statement 610, hover help dialog box 630 contains classpath display 640 showing the classpath for import statement 610 and JAR file display 650 showing the name and location of JAR file containing import statement 610.

A preferred form of the invention has been shown in the drawings and described above, but variations in the preferred form will be apparent to those skilled in the art. One skilled in the art will see that the Classpath Identifier can be applied to the migration of many different types of applications from a first environment to a second environment. In addition to JAVA applets, the Classpath Identifier can by used with servlets, weblets, and non-JAVA based applications and sub-applications. Further, Classpath Identifier can be used with any help dialog box implementation known in the art, not just hover help. The preceding description is for illustration purposes only, and the invention should not be construed as limited to the specific form shown and described. The scope of the invention should be limited only by the language of the following claims.

What is claimed is:

1. A computer implemented process for displaying a classpath associated with a line of computer code, the computer implemented process comprising:
responsive to a help dialog box related to a line of code being activated in a debugger;
obtaining from a compiler the classpath associated with the line of code; and
displaying the classpath in the help dialog box.

2. The computer implemented process of claim 1 further comprising:
identifying a name and a location of a JAR file containing the line of code; and
displaying the name and the location of the JAR file in the help dialog box.

3. The computer implemented process of claim 1 wherein the line of code is part of a JAVA application.

4. The computer implemented process of claim 1 wherein the line of code is part of a JAVA applet.

5. The computer implemented process of claim 1 wherein the line of code is part of a servlet.

6. The computer implemented process of claim 1 wherein the line of code is a JAVA import statement.

7. An apparatus for displaying a classpath associated with a line of computer code, the apparatus comprising:
a processor;
a memory connected to the processor;
a source code file in the memory;
a compiler running in the memory;
a debugger running in the memory, wherein the debugger is operable to display a help dialog box with information related to a line of code in the source code;
a classpath identifier program in the memory operable to:
obtain from a compiler the classpath associated with the line of code in response to the help dialog box related to a line of code being activated in the debugger; and
display the classpath in the help dialog box.

8. The apparatus of claim 7 wherein the classpath identifier program in the memory is further operable to identify a name and a location of a JAR file containing the line of code and to display the name and the location of the JAR file in the help dialog box.

9. The apparatus of claim 7 wherein the source code is a JAVA application.

10. The apparatus of claim 7 wherein the source code is a JAVA applet.

11. The apparatus of claim 7 wherein the source code is a servlet.

12. The apparatus of claim 7 wherein the line of code is a JAVA import statement.

13. A computer readable memory containing a plurality of instructions to cause a computer to display a classpath associated with a line of computer code, the plurality of instructions comprising:
responsive to a help dialog box being opened in a debugger for a line of code, a first instruction to obtain from a compiler the classpath associated with the line of code; and
a second instruction to display the classpath in the help dialog box.

14. The computer readable memory of claim 11 further comprising:
a third instruction to identify a name and a location of a JAR file containing the line of code; and at least one JAR file in the help dialog box.

15. The computer readable memory of claim 11 wherein the line of code is part of a JAVA application.

16. The computer readable memory of claim 11 wherein the line of code is part of a JAVA applet.

17. The computer readable memory of claim 11 wherein the line of code is part of a servlet.

18. The computer readable memory of claim 11 wherein the line of code is a JAVA import statement.
